(19) United States
(12) Patent Application Publication
(10) Pub. No.: US 2026/0361658 A1
(43) Pub. Date: Nov. 12, 2026

(54) SCHEDULING METHOD, ELECTRONIC APPARATUS, AND STORAGE MEDIUM

(71) Applicant: Beijing Zitiao Network Technology Co., Ltd., Beijing (CN)

(72) Inventors: Linhui LOU, Beijing (CN); Wangqiu YOU, Beijing (CN); Yingwu WANG, Beijing (CN); Pei XU, Beijing (CN)

(21) Appl. No.: 19/543,498

(22) Filed: Feb. 18, 2026

(30) Foreign Application Priority Data
May 12, 2025 (CN) 202510608224.9

(51) Int. Cl. H04L 47/28; H04L 41/0668; H04L 67/141

(52) U.S. Cl. CPC H04L 47/28; H04L 41/0668; H04L 67/141

(57) ABSTRACT

The present disclosure provides a scheduling method for a first cloud of a plurality of clouds, a scheduling method for an edge, an electronic apparatus, and a non-transitory computer-readable storage medium. The scheduling method for the first cloud of the plurality of clouds includes determining, according to delay-capacity information, a target cloud to be connected to an edge from the plurality of clouds in response to a connection request from the edge, the delay-capacity information including information of transmission delay amounts between the edge and the plurality of clouds, and information of capacity occupancies of the plurality of clouds, which are obtained at the first cloud; and sending information of the target cloud to the edge.

### CROSS-REFERENCE TO RELATED APPLICATION

The present disclosure claims priority of the Chinese Patent Application No. 202510608224.9 filed on May 12, 2025, the disclosure of which is incorporated herein by reference in its entirety as part of the present application.

### TECHNICAL FIELD

Embodiments of the present disclosure relate to a scheduling method for a cloud, a scheduling method for an edge, an electronic apparatus, and a non-transitory computer-readable storage medium.

### BACKGROUND

Cloud-Edge Collaboration is a distributed computing paradigm that combines cloud computing with edge computing. By integrating resources, computing power, and services of the cloud and the edge, Cloud-Edge Collaboration enables efficient data processing, intelligent task allocation, and collaborative system optimization. The core objectives of Cloud-Edge Collaboration are to reduce latency, save bandwidth, improve real-time performance, while maintaining the powerful global computing and analysis capabilities of the cloud.

### SUMMARY

According to an aspect of the present disclosure, at least one embodiment provides a scheduling method for a first cloud of a plurality of clouds, including: in response to a connection request from an edge, determining, according to delay-capacity information, a target cloud (for example, a second cloud) to be connected to the edge from the plurality of clouds, the delay-capacity information including information of transmission delay amounts between the edge and the plurality of clouds, and information of capacity occupancies of the plurality of clouds, which are obtained at the first cloud; and sending information of the target cloud to the edge.

According to an aspect of the present disclosure, at least one embodiment provides a scheduling method for an edge, including: sending a connection request to a plurality of clouds; receiving, from the plurality of clouds, information of a plurality of target clouds (for example, second clouds) to be connected to the edge, the plurality of target clouds being respectively determined by the plurality of clouds, each of the plurality of target clouds being determined by a corresponding one of the plurality of clouds according to delay-capacity information, and the delay-capacity information being based on information of transmission delay amounts between the edge and the plurality of clouds and information of capacity occupancies of the plurality of clouds, the information of transmission delay amounts and the information of capacity occupancies being obtained at the corresponding one of the plurality of clouds; selecting, from the plurality of target clouds, a cloud to be actually connected; and connecting to the cloud to be actually connected.

According to an aspect of the present disclosure, at least one embodiment provides a cloud, including: a determining apparatus, configured to, in response to a connection request from an edge, determine, according to delay-capacity information, a target cloud to be connected to the edge from a plurality of clouds including the cloud, the delay-capacity information including information of transmission delay amounts between the edge and the plurality of clouds and information of capacity occupancies of the plurality of clouds, which are obtained at the cloud; and a sending apparatus, configured to send information of the target cloud to the edge.

According to an aspect of the present disclosure, at least one embodiment provides an edge, including: a sending apparatus, configured to send a connection request to a plurality of clouds; a receiving apparatus, configured to receive, from the plurality of clouds, information of a plurality of target clouds to be connected to the edge that are determined by the plurality of clouds, each of the plurality of target clouds being determined by a first cloud of the plurality of clouds according to delay-capacity information, and the delay-capacity information being based on information of transmission delay amounts between the edge and the plurality of clouds and information of capacity occupancies of the plurality of clouds, which are obtained at the first cloud of the plurality of clouds; a selecting apparatus, configured to select, from the plurality of target clouds, a cloud to be actually connected; and a connecting apparatus, configured to connect to the cloud to be actually connected.

According to an aspect of the present disclosure, at least one embodiment provides an electronic apparatus, including: at least one memory storing computer instructions; and at least one processor configured to execute the computer instructions in the at least one memory to perform the method according to at least one embodiment of the present disclosure.

According to an aspect of the present disclosure, at least one embodiment provides a non-transitory computer-readable storage medium having computer instructions stored thereon, where the computer instructions, when executed by at least one processor, cause the at least one processor to perform the method according to at least one embodiment of the present disclosure.

### BRIEF DESCRIPTION OF DRAWINGS

The foregoing and other features, advantages, and aspects of embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic diagram of a system in which data transmission is performed between a cloud and an edge;

FIG. 2 is a schematic diagram of a system in which traffic scheduling is performed between a cloud and an edge according to at least one embodiment of the present disclosure;

FIG. 3 is a flowchart of a scheduling method for a first cloud of a plurality of clouds according to at least one embodiment of the present disclosure;

FIG. 4 is a schematic diagram of an example of a comprehensive indicator according to at least one embodiment of the present disclosure;

FIG. 5 is a schematic diagram of an example of the number of edges connected to two clouds varying with capacity occupancy when a second capacity indicator is added to a comprehensive indicator according to at least one embodiment of the present disclosure;

FIG. 6A is a schematic diagram of the amount of disaster recovery resources that need to be prepared by each of all clouds to connect to all edges in a disaster recovery scenario;

FIG. 6B is a schematic diagram of the amount of disaster recovery resources of a plurality of clouds in a disaster recovery scenario according to at least one embodiment of the present disclosure;

FIG. 7 is a flowchart of a scheduling method for an edge according to at least one embodiment of the present disclosure;

FIG. 8 is a schematic diagram of example operations of an edge according to at least one embodiment of the present disclosure;

FIG. 9 is a flowchart of example operations in which an edge selects a cloud to be actually connected to according to an arbitration rule according to at least one embodiment of the present disclosure;

FIG. 10 is a block diagram of a cloud according to at least one embodiment of the present disclosure;

FIG. 11 is a block diagram of an edge according to at least one embodiment of the present disclosure; and

FIG. 12 is a block diagram of an electronic apparatus suitable for implementing at least one embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for more thorough and complete understanding of the present disclosure. It should be understood that the drawings and embodiments of the present disclosure are only used for illustrative purposes, and are not used to limit the scope of protection of the present disclosure.

It should be understood that the various steps described in the method implementations of the present disclosure may be performed in different orders and/or in parallel. In addition, the method implementations may include additional steps and/or omit the execution of the illustrated steps. The scope of the present disclosure is not limited in this regard.

The term "include/comprise" and its variations used herein are open-ended inclusions, that is, "include/comprise but not limited to". The term "based on" is "at least partially based on". The term "an embodiment" means "at least one embodiment". The term "another embodiment" means "at least one another embodiment". The term "some embodiments" means "at least some embodiments". Relevant definitions of other terms are given in the description below.

It should be noted that concepts such as "first" and "second" mentioned in the present disclosure are only used to distinguish different apparatuses, modules, or units, and are not used to limit the order or interdependence of the functions performed by these apparatuses, modules, or units.

It should be noted that the modifications of "a" and "a plurality of" mentioned in the present disclosure are illustrative and not restrictive. Those skilled in the art should understand that unless otherwise clearly indicated in the context, they should be understood as "one or more".

Note that herein, "performing B in response to A" may mean "performing B in the case of A", "performing B when A occurs", and the like, and is not limited to performing B immediately after A occurs, nor is it limited to the time and sequence in which A and B occur.

The names of messages or information exchanged between a plurality of apparatuses in the implementations of the present disclosure are only used for illustrative purposes, and are not used to limit the scope of these messages or information.

In the cloud-edge collaboration process, the cloud computing is able to provide large-scale storage, high-performance computing, and complex analysis capabilities based on centralized data center devices, and is suitable for non-real-time and global data processing. The edge computing is able to sink computing power to edge node devices (such as intelligent gateways and local servers) close to data sources, focus on real-time data processing and low-latency response, and reduce the latency and bandwidth consumption of data transmission to the cloud. Cloud computing is typically performed by a cloud service center device (for example, a server) (abbreviated as a cloud). The cloud service center device may be a centralized remote data center cluster (for example, a public cloud or a private cloud), which provides large-scale storage, high-performance computing, and global data analysis services. The cloud may be composed of a large-scale server cluster. Edge computing is typically performed by an edge node device. The edge node device (abbreviated as an edge) refers to a small-scale service platform built on the network edge side close to users, which provides resources such as storage, computing, and network, and sinks some key service applications to the edge of the access network to reduce the width and delay loss caused by network transmission and multi-level forwarding. The edge may be composed of a small server unit. Note that the cloud and the edge are different terms formed according to different divisions of labor and different scales in a cloud-edge collaboration environment, but both may be composed of servers. The user side may use an end device to access the edge node device for network data transmission, resource management, security processing, privacy protection, and so on.

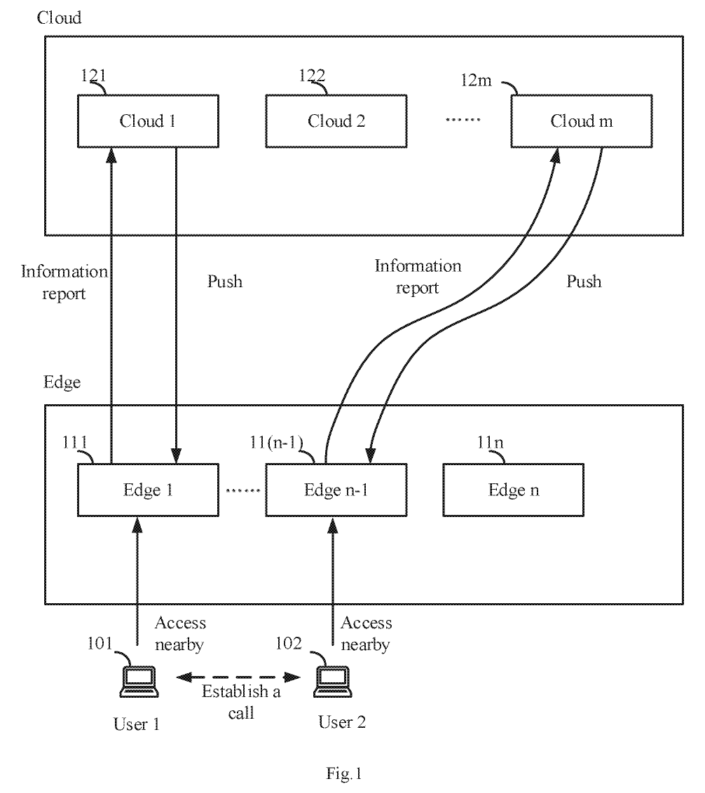

FIG. 1 is a schematic diagram of a system in which data transmission is performed between a cloud and an edge.

A process of data transmission between a cloud and an edge in a real-time communication (RTC) scenario is shown in FIG. 1. There are a plurality of clouds in this scenario, for example, m clouds: clouds 121, 112, ..., and 12m, where m is a positive integer. In addition, there are a plurality of edges in this scenario, for example, n edges: edges 111, ..., 11(n-1), ..., and 11n, where n is a positive integer. For example, the plurality of clouds are communicatively connected to each other, and each edge is communicatively connected to at least one cloud. A communication connection manner includes but is not limited to a wired network, a wireless network, or the like.

Herein, each of the cloud or the edge may include a processor, a memory (such as an internal memory or an external memory, not shown), a communication module, and the like. The processor in the present disclosure includes a unit responsible for executing instructions stored in the memory and processing various data operations and logical operations. The processor may include a central processing unit (CPU), a graphics processing unit (GPU), etc. The processor may be a processor that adopts various applicable architectures or instruction sets, such as x86, advanced reduced instruction set computer machines (ARM), reduced instruction set computer-V (RISC-V), million instructions per second (MIPS), etc.

The cloud-edge collaboration solution may be applied to various scenarios, which is described below by using an RTC application scenario as an example. Other application scenarios to which the cloud-edge collaboration solution may be applied are not described herein. RTC is real-time audio and video communication. To meet the low-latency and high-availability requirements of the RTC scenario, a cloud-edge collaboration architecture is usually used, for example, the scenario shown in FIG. 1. As shown in FIG. 1, for example, if user 1 wants to establish an RTC call, for example, with user 2, user 1 may access, through the terminal device 101 of user 1, an edge 111 that is geographically close to the terminal device 101 of user 1. The edge 1 111 may establish communication with a nearby cloud 121 to complete data transmission such as information reporting and information pushing. The main services of the terminal device 101 of user 1 are locally processed by the edge 111, to reduce the response latency of a request of user 1, and the cloud 121 may perform non-real-time and global data processing. Herein, the main services may include data preprocessing, real-time decision-making, local storage, security and privacy protection, resource management and optimization, model inference, and the like. Similarly, user 2 may access, through the terminal device 102 of user 2, an edge 11(n-1) that is geographically close to the terminal device 102 of user 2. The edge 11(n-1) may establish communication with a nearby cloud 12m to complete data transmission such as information reporting and information pushing. All the main services of user 2 are locally processed by the edge 112, to reduce the response latency of a request of user 2, and the cloud 12m may perform non-real-time and global data processing.

The foregoing cloud-edge collaboration solution has the following features: The edge is highly sunken, and the user accesses the nearby edge, to reduce the first mile latency; the service logic is locally processed by the edge, to reduce the response latency of the request of the edge; the cloud acts as a super brain, and the edge is not completely autonomous. The edge synchronizes state information to the cloud, and the cloud distributes the state information, to improve reliability; and to eliminate the single point of failure risk of the cloud and reduce the communication latency between the cloud and the edge, a plurality of clouds need to be deployed, and traffic of a failed cloud is supported by redundant resources of the clouds.

Several thousands of edges and several clouds may be deployed around the world, and the cloud-edge collaboration solution needs to perform appropriate cloud-edge connection, that is, the edge needs to select an appropriate cloud to establish communication. For example, a cloud-edge connection solution considers only load balancing of resources at the cloud, for example, a round robin algorithm, a random algorithm, a hash algorithm, and the like. However, for a delay-sensitive RTC service, if the cloud-edge delay is not considered, the user experience of the RTC system may be impaired. For example, an increase of 100 ms in the cloud-edge transmission delay may significantly reduce the RTC 3s/5s room entry success rate. In addition, the cloud-edge connection solution considers only the latency from the edge to the cloud, and uses a nearby access manner. The edge independently decides which center to connect to based on the detected latency. This makes it completely determined by the edge itself which cloud to connect to, and it is impossible to accurately predict how many edges will be connected to the cloud. If the resources of the cloud are insufficient, the cloud may be overloaded, or the cloud may prepare resources based on the maximum value, resulting in resource waste.

The defect of the foregoing solution is obtained by the inventors of the present disclosure after careful study through practice and creative efforts. The process of discovering the foregoing problem and the solution to the foregoing problem proposed in at least one embodiment of the present disclosure below are all creative contributions.

According to at least one implementation of the present disclosure, the information obtained through comprehensive consideration by the cloud, including the information of the transmission delay amounts between the edge and the plurality of clouds and the information of the capacity occupancies of the plurality of clouds that are obtained at the cloud, is used to determine the target cloud to be connected to the edge from the plurality of clouds. In this way, during cloud-edge connection, the cloud may comprehensively consider the cloud-edge delays between the respective clouds and the edge and the resource capacity occupancy of the respective clouds, and dynamically schedule the edge that initiates the access request to an appropriate cloud, so that the edge is connected to the appropriate cloud and the cloud is responsible for the services of the edge. Further, at least one implementation of the present disclosure may ensure the service quality of a service such as a delay-sensitive RTC service, reasonably allocate the resources of the clouds, and avoid exceeding the load of the cloud.

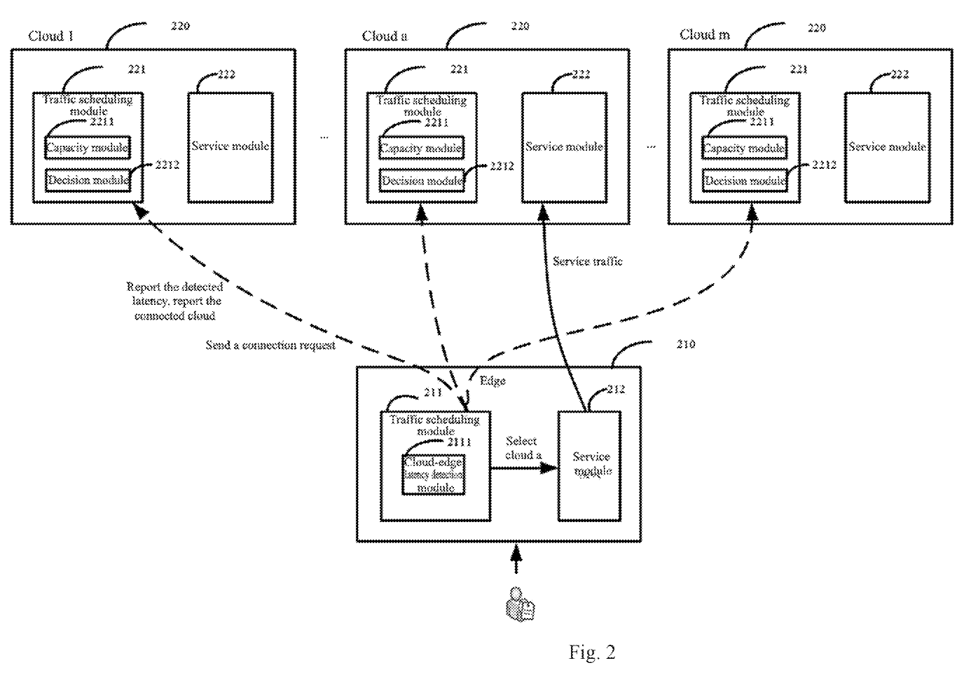

FIG. 2 is a schematic diagram of a system in which traffic scheduling is performed between a cloud and an edge according to at least one embodiment of the present disclosure.

As shown in FIG. 2, the system 200 includes a plurality of clouds 220, for example, m clouds shown in FIG. 2: cloud 1, cloud 2, ..., cloud a, ..., and cloud m, where a and m are positive integers, and a < m. The system 200 further includes a plurality of edges, for example, an edge 210. A user terminal device may access the edge nearby. The edge 210 may include a traffic scheduling module 211, configured to request traffic scheduling from the plurality of clouds 220, for example, send a connection request, to connect to a specific cloud for traffic transmission, and obtain a cloud-edge traffic scheduling result from the cloud 220. The edge 210 may initiate the connection request in the following scenarios: when the edge starts, the edge connects to a cloud for the first time; the edge suddenly cannot connect to a current cloud due to a network reason, and initiates active switching; the edge switches to a cloud with higher latency due to a short-term network reason, and needs to switch back after the network is restored; a center configuration changes, and the edge is notified to re-select a cloud to connect to, for example, the capacity of the cloud changes; a cloud fails, and traffic needs to be switched to another cloud, and so on.

For example, the traffic scheduling module 211 may include a cloud-edge latency detection module 2111, configured to detect transmission delay amounts between the edge and the plurality of clouds, and send information of the detected transmission delay amounts between the edge and the plurality of clouds to the plurality of clouds (report the detected latency). The cloud-edge latency detection module 2111 may periodically detect the latency (for example, by sending a signal to the cloud and detecting the time it takes to return a signal from the cloud), or may detect the latency while sending the connection request, before sending the connection request, or after sending the connection request. The traffic scheduling module 211 is further configured to: after receiving, from the plurality of clouds 220, information of a plurality of target clouds to be connected to the edge 210 that are determined by the plurality of clouds 220, select, from the plurality of target clouds, a cloud to be actually connected (for example, cloud a), and connect to the cloud to be actually connected (for example, cloud a).

The traffic scheduling module 211 may be further configured to send information of the actually connected cloud (for example, cloud a) to each of the plurality of clouds 220 (periodically or after connecting to the cloud).

Each cloud may include a traffic scheduling module 221, configured to schedule traffic for the edge 210, that is, determine which cloud the edge 210 should connect to for traffic transmission.

The traffic scheduling module 221 may include a capacity module 2211, configured to obtain and record information of the capacity occupancy of each of the plurality of clouds 220, and may be configured to set and record information such as the capacity quota of each cloud. For example, the capacity quota may refer to the number of edges that may be carried, and the capacity quota may depend on the computing and storage resources of each cloud. For example, if the computing resources of cloud a may process the cloud-edge traffic of 1,500 edges, the quota of cloud a is set to 1,500. When a specific cloud fails, the quota of the failed cloud is set to 0, so that the connected edges are disconnected, and no new edge is connected. The capacity occupancy may refer to the number of edges connected to the cloud, a ratio of the number of edges connected to the cloud to the capacity quota of the cloud, or other information related to the capacity occupancy, which for example, may also be referred to as a water level.

The traffic scheduling module 221 of each cloud 220 may further include a decision module 2212, configured to: in response to the connection request from the edge, determine, according to the delay-capacity information, a target cloud (for example, cloud a) to be connected to the edge from the plurality of clouds. The delay-capacity information may include information of the transmission delay amounts between the edge 210 and the plurality of clouds 220, and the information of the capacity occupancies of the plurality of clouds 220 obtained and recorded at the capacity module 2211 of each cloud.

The traffic scheduling module 221 may further send the information of the determined target cloud to the edge 210. Each cloud 220 may determine one target cloud, and send information of the (alternate) target cloud determined by each cloud to the edge 210, for example, cloud 1 determines cloud a as a target cloud, cloud 2 determines cloud 1 as a target cloud, ..., cloud a determines cloud 2 as a target cloud, ..., cloud m determines cloud a as a target cloud, and so on. That is, the edge 210 may receive a plurality of target clouds (which may be at least partially the same), and then the edge 210 selects a cloud to be actually connected to from these target clouds.

As shown in FIG. 2, if the edge 210 selects to connect to cloud a, after the edge 210 is actually connected to cloud a, the service module 212 of the edge 210 and the service module 222 of cloud a transmit service traffic.

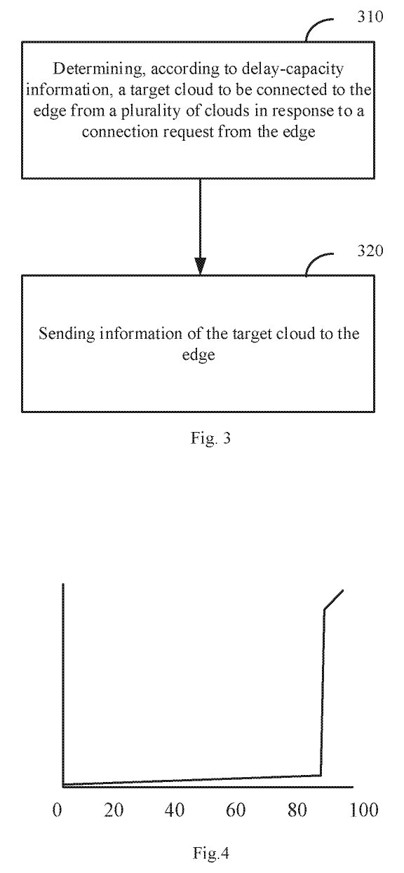

FIG. 3 is a flowchart of a scheduling method for a first cloud of a plurality of clouds according to at least one embodiment of the present disclosure.

As shown in FIG. 3, the scheduling method for the first cloud of the plurality of clouds includes step 310 and step 320. Herein, the "first cloud" is merely for ease of description, and it may refer to any cloud. The cloud is used as a description object, and is not limited to the first cloud or the like. The method may be applied to each of the plurality of clouds, and the cloud may include computing resources such as a memory, a processor, and a communication apparatus to perform the scheduling method. For example, the method may be performed by, for example, the traffic scheduling module 221 of the cloud shown in FIG. 2.

In step 310, the first cloud determines, according to delay-capacity information, a target cloud (for example, a second cloud) to be connected to an edge from the plurality of clouds in response to a connection request from the edge. The delay-capacity information includes information of transmission delay amounts between the edge and the plurality of clouds, and information of capacity occupancies of the plurality of clouds, which are obtained at the first cloud.

It is assumed that there are m clouds (where m is a positive integer), and the first cloud is one of them, for example, the first cloud. The first cloud determines, based on the obtained information of transmission delay amounts between the edge and each of the m clouds (for example, D1, D2, ..., and Dm) and the obtained information of capacity occupancies of each of the m clouds (for example, C1, C2, ..., and Cm), one target cloud to be connected to the edge, for example, an ath cloud or cloud a (where a is a positive integer), from the plurality of clouds.

The information of the transmission delay amounts between the edge and each of the m clouds (for example, D1, D2, ..., and Dm) recorded at the first cloud may come from the transmission delay amounts reported by the edge periodically, aperiodically, or together with the connection request, or may come from the transmission delay amounts detected and recorded by other devices. The information of the capacity occupancies of each of the m clouds (for example, C1, C2, ..., and Cm) recorded at the first cloud may be automatically updated by the first cloud based on the information of the actually connected cloud sent by the edge, or may be obtained by synchronizing capacity occupancy synchronization information from other clouds or other devices, to obtain the information of the capacity occupancies of all the clouds. The source of the information is not limited herein.

In step 320, the first cloud sends information of the target cloud (for example, information of cloud a) to the edge. Therefore, the edge that sends the connection request may consider whether to actually connect to the information of the target cloud (for example, the information of cloud a).

In this way, during cloud-edge connection, the cloud may comprehensively consider the cloud-edge delays between the respective clouds and the edge and the resource capacity occupancy of the respective clouds, and dynamically schedule the edge to an appropriate cloud, so that the edge is connected to the cloud and the cloud is responsible for the services of the edge.

In some embodiments, step 310 may include: obtaining, by the first cloud, a comprehensive indicator for each of the plurality of clouds based on the transmission delay amount and the capacity occupancy.

For example, the comprehensive indicator may include a value calculated based on a first indicator and a second indicator. The target cloud may be determined in response to a comparison between the comprehensive indicators of the plurality of clouds.

For example, the first indicator may be positively correlated with the transmission delay amount. The first indicator may be referred to as detected latency points. For example, the first indicator may be the transmission delay amount itself (in ms, and a maximum value is 5000).

For example, the second indicator may be positively correlated with the capacity occupancy when the capacity occupancy is greater than or equal to a capacity threshold. The second indicator is set to be positively correlated with the capacity occupancy when the capacity occupancy is greater than or equal to the capacity threshold, so that the impact of the transmission delay amount may be preferentially considered when the capacity occupancy is small, to obtain a fast data transmission effect. However, if the capacity occupancy is excessively large, the cloud may be overloaded. Therefore, the impact of the capacity occupancy further needs to be considered, and a cloud with an excessively large capacity occupancy needs to be avoided as much as possible, to avoid overloading the cloud. Herein, the capacity occupancy may refer to the number of edges connected to the cloud, a ratio of the number of edges connected to the cloud to the capacity quota of the cloud, or other information related to the capacity occupancy. In the following description, the ratio of the number of edges connected to the cloud to the capacity quota of the cloud is used as an example of the capacity occupancy. In an example, when the capacity occupancy is the ratio of the number of edges connected to the cloud to the capacity quota of the cloud, the capacity threshold may be 10% or 90%, that is, the second indicator may be set to be positively correlated with the capacity occupancy (ratio) when the ratio of the number of edges connected to the cloud to the capacity quota of the cloud is greater than or equal to 10% or 90%. The capacity threshold may be set to another size, which depends on the amount of capacity occupancy that is expected to be avoided to prevent a capacity overload.

In an embodiment, the comprehensive indicator = the first indicator + the second indicator. However, another formula may be used, for example, the comprehensive indicator = c1 * the first indicator + c2 * the second indicator + c3, where c1, c2, and c3 are natural numbers; or the comprehensive indicator = the first indicator * the second indicator; and so on.

It is usually expected to determine a cloud with a small transmission delay amount and an appropriate capacity occupancy as the target cloud to be connected to the edge. Therefore, by combining the first indicator that is positively correlated with the transmission delay amount and the second indicator that is positively correlated with the capacity occupancy when the capacity occupancy is greater than or equal to the capacity threshold, a target cloud with a smaller comprehensive indicator may be more easily determined as a suitable target cloud that meets the conditions. In this way, a transmission delay between the edge and the cloud may be ensured to be small, the service quality of a service such as a delay-sensitive RTC service is improved, and the resources of the clouds are reasonably allocated to avoid exceeding the load of the cloud.

In some embodiments, the second indicator may include a first capacity indicator. The first capacity indicator may be a first constant when the capacity occupancy is less than a protection threshold. The first capacity indicator may be greater than or equal to a first value when the capacity occupancy is greater than or equal to the protection threshold. The first value may be positively correlated with the capacity occupancy. The first value may be of the same order of magnitude as a maximum value of the transmission delay amount. The protection threshold may be greater than the capacity threshold.

The first value is set to (greatly) improve the impact of the first capacity indicator on the comprehensive indicator when the capacity occupancy is excessively large, so that a cloud with an excessively large capacity occupancy is avoided as much as possible. Herein, the impact of the first indicator that is positively correlated with the transmission delay amount needs to be offset. Therefore, it may be specified that the first value is of the same order of magnitude as the maximum value of the transmission delay amount. For example, the maximum value of the transmission delay amount may be 5000 ms, and the first value may also be of the order of thousands.

For example, the first value may be set to be positively correlated with the capacity occupancy, for example, the capacity occupancy multiplied by a coefficient or a negative value of a coefficient divided by the capacity occupancy.

In some embodiments, the first value may have a rang from half of the maximum value of the transmission delay amount to the maximum value of the transmission delay amount. In an example, the first value is 5000/(2-capacity occupancy). Because the capacity occupancy ranges from 0% to 100%, the first value may range from 2500 to 5000, which is of the same order of magnitude as the maximum value of 5000 for the transmission delay amount, and the value range is between half of the maximum value of the transmission delay amount and the maximum value of the transmission delay amount.

In an example, the first constant is 1, and the protection threshold is 90%. In this way, for example, when the comprehensive indicator = the first indicator + the second indicator, and the first indicator may be the transmission delay amount itself, if the current capacity occupancy is less than 90%, the comprehensive indicator = the transmission delay amount (in ms) + 1; or if the current capacity occupancy is greater than or equal to 90%, the comprehensive indicator = the transmission delay amount (in ms) + 5000/(2-capacity occupancy). For example, if the current capacity occupancy is 10%, the first capacity indicator may be 1; or if the current capacity occupancy is 90%, the first value is 5000/(2-90%) = 4545.45.

Herein, the first capacity indicator may also be referred to as capacity occupancy penalty points, because the first capacity indicator is increased as a penalty when the capacity occupancy of the cloud is large, making it less likely to select a cloud with a large capacity occupancy when selecting a cloud with a smaller comprehensive indicator.

FIG. 4 is a schematic diagram of an example of a comprehensive indicator according to at least one embodiment of the present disclosure.

As shown in FIG. 4, when the capacity occupancy of the cloud is less than 90%, the comprehensive indicator may be basically stable, but when the capacity occupancy of the cloud is greater than or equal to 90%, the comprehensive indicator increases sharply.

In this way, when the capacity occupancy is excessively large (extremely large), the impact of the capacity occupancy on the comprehensive indicator is increased (the greater the capacity occupancy, the greater the impact on the comprehensive indicator), so that the comprehensive indicator is sharply increased. Then, a cloud with a smaller comprehensive indicator may be selected by comparing the sizes of the comprehensive indicators, so that a cloud with an excessively large capacity occupancy is avoided as much as possible while a cloud with a small transmission delay amount is selected as much as possible, to avoid overloading the cloud.

In some embodiments, the second indicator may further include a second capacity indicator. The second capacity indicator may be a second constant when the capacity occupancy is less than the capacity threshold. The second capacity indicator may be greater than or equal to a second value when the capacity occupancy is greater than or equal to the capacity threshold. The second value may be positively correlated with the capacity occupancy. The second value may differ from an inherent delay difference between the transmission delay amounts of the plurality of clouds by less than two orders of magnitude. For example, the second value may differ from the inherent delay difference among the transmission delay amounts of the plurality of clouds by less than one order of magnitude.

The second capacity indicator may be referred to as capacity load balance points, which may compensate for the impact of the inherent delay difference among the transmission delay amounts of the plurality of clouds on the comprehensive indicator when the inherent delay difference among the transmission delay amounts of the plurality of clouds is small, that is, the transmission delays from the edge to the plurality of clouds are similar, so that the cloud with the smallest delay is not always scheduled to connect to the edge, and a balanced allocation is performed among the plurality of clouds as much as possible.

For example, cloud a and cloud b (a and b are different from each other) share the public network egress of cloud a, and the two clouds are interconnected through a network (for example, a dedicated line) with a latency of 2 to 3 ms. Theoretically, the latency difference between all edges to cloud a and cloud b is between 2 and 3 ms, and the latency of cloud b is always higher than that of cloud a. This results in that, considering the first indicator (positively correlated with the transmission delay amount) in the comprehensive indicator, cloud a with a smaller latency is always determined to connect to each edge that sends a connection request, resulting in that more and more capacity of cloud a is occupied, and cloud b is never determined to connect to an edge, resulting in an increasing imbalance in the load between the two clouds. Therefore, in such a scenario, setting the second value that differs from 2 to 3 ms by less than two orders of magnitude may balance the scheduling of edges around the region to one of the two clouds as much as possible, instead of only scheduling to cloud a with a consistently lower latency. For example, if the latency difference is 2 to 3 ms, the second value may range from 0 to 100; or if the latency difference is 10 ms, the second value may range from 10 to 1000.

In an example, for example, the capacity threshold may be 10%, the second constant may be 0, and the second value may be the current capacity occupancy * c4, where c4 is a coefficient. The coefficient is configurable. The lower the value, the greater the impact of the latency difference; and the higher the value, the greater the impact of the capacity occupancy. For example, c4 = 100, and the capacity occupancy ranges from 0% to 100%. Therefore, when the capacity occupancy is greater than or equal to 10%, the second value may range from 10 to 100, so that the second value differs from the order of magnitude of the foregoing inherent latency difference by less than two orders of magnitude. Therefore, when the capacity occupancy is greater than or equal to 10%, the impact of the second value on the comprehensive indicator exceeds the impact caused by the inherent latency difference. This may enable that when considering the comprehensive indicator (including the first indicator positively correlated with the transmission delay amount and the second capacity indicator positively correlated with the capacity occupancy), as the capacity occupancies of cloud a and cloud b respectively increase, sometimes cloud a and sometimes cloud b may be determined, based on the size of the comprehensive indicator, to connect to each edge that sends a connection request, so that the loads of cloud a and cloud b are basically balanced.

FIG. 5 is a schematic diagram of an example of the number of edges connected to two clouds varying with the capacity occupancy when a second capacity indicator is added to a comprehensive indicator according to at least one embodiment of the present disclosure.

As shown in FIG. 5, when the capacity occupancy of the cloud is less than 10%, cloud a is basically always determined to be connected to the edge, which causes cloud a to be connected to more and more edges, resulting in an increase in the capacity occupancy and gradually exceeding 10%. When the capacity occupancy of cloud a is greater than or equal to 10%, the second capacity indicator in the comprehensive indicator calculated for cloud a considers the impact of the capacity occupancy, which increases the comprehensive indicator calculated for cloud a. Therefore, compared with the comprehensive indicator calculated for cloud b, the comprehensive indicator of cloud b may be smaller. Therefore, cloud b is determined to be connected to the edge, so that cloud b is connected to more and more edges. Further, after the capacity occupancy of cloud b increases, the comprehensive indicator calculated for cloud b increases. Therefore, compared with the comprehensive indicator calculated for cloud a, the comprehensive indicator of cloud a may be smaller. Therefore, cloud a is determined again to be connected to the edge, so that cloud a is connected to more and more edges. In this way, the number of edges connected to cloud a and cloud b may rise steadily in a balanced manner, that is, the capacity occupancies of the two clouds rise steadily, thereby basically balancing the loads of cloud a and cloud b.

The foregoing describes some embodiments of determining, based on the delay-capacity information, the target cloud to be connected to the edge from the plurality of clouds. However, the present disclosure is not limited thereto, and another manner may be used to determine, based on the delay-capacity information, the target cloud to be connected to the edge from the plurality of clouds.

For example, in some embodiments, step 310 may further include: determining, as the target cloud, one cloud of one or more clouds with a transmission delay amount less than a first threshold or with a smallest transmission delay amount and a capacity occupancy less than a second threshold or with a smallest capacity occupancy.

The foregoing conditions may include the following cases: a smallest transmission delay amount and a smallest capacity occupancy, a transmission delay amount less than the first threshold and a capacity occupancy less than the second threshold, a smallest transmission delay amount and a capacity occupancy less than the second threshold, and a transmission delay amount less than the first threshold and a smallest capacity occupancy. Smaller values may be selected for the first threshold and the second threshold, for example, the first threshold is 50 ms and the second threshold is 20%. There may be one or more clouds, or there may be no cloud, that meet the foregoing conditions. Therefore, it may be specified to select a specific cloud as the target cloud according to a predetermined rule. For example, the predetermined rule may be to use a last cloud in an alphabetical order of identifications ID as the target cloud. Examples are not described herein one by one.

In this way, a specific cloud with a small transmission delay amount and a small capacity occupancy may also be selected as the cloud to be connected to the edge, so that data transmission between the edge and the cloud is fast, and the cloud load is prevented from being exceeded.

In some embodiments, the delay-capacity information may further include respective capacity upper limits of the plurality of clouds, to further obtain the respective capacity upper limits of the plurality of clouds, and determine the target cloud to be connected to the edge by combining the information of the transmission delay amounts of the plurality of clouds and the capacity occupancies of the plurality of clouds.

For example, in some embodiments, the scheduling method may further include: obtaining a ratio between the respective capacity upper limits of the plurality of clouds, and determining the target cloud based on a probability corresponding to the ratio, so that a ratio of a probability of determining one cloud of the plurality of clouds as the target cloud to a probability of determining another cloud of the plurality of clouds as the target cloud is equal to a ratio of a capacity upper limit of the one cloud to a capacity upper limit of the another cloud.

For example, if the ratio between the capacity upper limit of cloud a and the capacity upper limit of cloud b is 1:2, the ratio of the probability of determining cloud a as the target cloud to the probability of determining cloud b as the target cloud is also 1:2. That is, generally, if cloud a is determined as the target cloud once, cloud b needs to be determined as the target cloud twice.

In this way, the number of times the plurality of clouds are determined as target clouds to be connected to the edge may be balanced based on the capacity upper limits, so that a cloud with a high capacity upper limit may be connected to more edges, and a cloud with a low capacity upper limit may be connected to fewer edges, thereby reasonably allocating cloud resources and avoiding unbalanced allocation of cloud resources or even exceeding a cloud load.

Certainly, the foregoing describes some examples of determining the target cloud to be connected to the edge based on the respective capacity upper limits of the plurality of clouds. However, the present disclosure is not limited thereto, and other examples may be used. For example, a third indicator related to the capacity upper limit is designed in the comprehensive indicator, so that the third indicator is negatively correlated with the capacity upper limit. In other words, a higher capacity upper limit of a cloud results in a lower third indicator, and thus a lower comprehensive indicator for the cloud, and the cloud is more likely to be determined as the target cloud to be connected to the edge. These other examples are not described herein one by one.

It is considered that there may be concurrent connection requests sent by a plurality of edges basically at the same time, which may cause each of the plurality of clouds to determine a same cloud to connect to these edges, which may cause the determined same cloud to be connected to numerous edges instantaneously, resulting in an instantaneous overload.

To solve the foregoing problem, in some embodiments, the scheduling method may further include: pre-updating, in response to determining the target cloud, the information of the capacity occupancy of the target cloud obtained at the first cloud to information of a capacity occupancy of the target cloud considered as being connected to the edge.

Herein, the pre-updated capacity occupancy for the target cloud may be calculated by pre-increasing, by 1, the number of edges connected to the target cloud recorded at the first cloud. For example, if the target cloud determined by the first cloud is cloud a, and the capacity occupancy is the number of connected edges divided by the maximum number of connectable edges, the pre-updated capacity occupancy of cloud a is the recorded number of connected edges plus 1, and then divided by the capacity upper limit of cloud a. This increases the capacity occupancy of cloud a, so that in response to a connection request sent by another edge, the first cloud determines, based on the already increased capacity occupancy of cloud a and the capacity occupancies of other clouds, a target cloud to be connected to the another edge. As a result, the probability of reselecting cloud a decreases, or cloud a may not be selected anymore, thereby avoiding determining cloud a for a plurality of edges, and preventing a sudden increase in the load of cloud a or even an overload.

In an embodiment of the present disclosure, the scheduling method may further include: receiving, from the edge, information of a cloud (for example, a third cloud) actually connected to the edge.

For example, the cloud actually connected to the edge depends on the result of the selection by the edge, and may or may not be cloud a determined by the first cloud. Therefore, the scheduling method may further include: maintaining the information of the pre-updated capacity occupancy of the target cloud (cloud a) in response to the information of the cloud actually connected to the edge being the same as the information of the target cloud (for example, the edge is actually connected to cloud a).

Alternatively, the scheduling method may further include: in response to the information of the cloud actually connected to the edge being different from the information of the target cloud (for example, the edge is actually connected to cloud b), reverting the information of the pre-updated capacity occupancy of the target cloud (cloud a) to the information of the capacity occupancy before pre-updating (for example, the recorded number of connected edges of cloud a minus 1), and updating the information of the capacity occupancy of the actually connected cloud (cloud b) obtained at the first cloud. In this way, the information of the capacity occupancies of the plurality of clouds obtained and recorded at the first cloud is still relatively accurate.

In addition, the scheduling method may further include routing connection requests of all edges to a single instance of a processor for processing. The "single instance" herein may refer to a specific logical or physical unit that performs a centralized processing task, and may be a software service instance, a virtual machine, a container, or a physical server, which receives and processes requests from the edges in a unified manner. In other words, after the single instance completes processing for one edge, the single instance is then used to process the next edge, thereby ensuring that when a plurality of edges concurrently send connection requests, appropriate clouds are determined one by one in sequence, thereby preventing the cloud from determining a same cloud for the plurality of edges to connect to these edges, and further preventing the determined same cloud from being instantaneously connected to numerous edges, resulting in an instantaneous overload.

In addition, in at least one embodiment, the scheduling method may further include using a memory lock to control to allow only one thread to access the shared memory at a specific moment, to avoid an error caused by a plurality of threads modifying data at the same time, thereby preventing the problem of concurrent connection requests.

In some embodiments, to prevent a cloud from frequently disconnecting an edge when resources are limited, causing the edge to repeatedly disconnect from and reconnect to the same cloud or different clouds (that is, repeatedly jump), the scheduling method may further include: refusing to determine the first cloud as the target cloud or refusing to connect to a new edge in response to the capacity occupancy of the first cloud being greater than or equal to a first water level threshold; and disconnecting the first cloud from one or more edges in response to the capacity occupancy of the first cloud being greater than or equal to a second water level threshold, where the second water level threshold is greater than the first water level threshold.

In an example, the first water level threshold may be 95%, and the second water level threshold may be 100%. In other words, when the capacity occupancy of the first cloud is greater than or equal to 95%, the first cloud is no longer determined as the target cloud, or a new edge is refused to be connected, to ensure that the resources of the first cloud do not remain in a tense state and edges are not frequently disconnected. When the capacity occupancy of the first cloud reaches 100%, the connection to one or more connected edges may be disconnected, to reduce the capacity occupancy, release resources, and avoid frequent scheduling failures and resource reclamation caused by insufficient resources.

When a regional failure occurs in a specific cloud, a large number of edges connected to the cloud are all disconnected, which may cause a large number of concurrent connection requests from the large number of edges to occur instantaneously, resulting in instantaneous resource tension or overload in the cloud. To solve this problem, in some embodiments, the scheduling method may further include: in response to a failure of the first cloud, dispersing time points of sending a failure notification to a plurality of edges connected to the first cloud to a plurality of different time points; and sending the failure notification to the plurality of edges at the plurality of different time points, respectively.

For example, a dispersion manner may be performing hash processing on identifications ID of, for example, 30 edges, and mapping the identifications ID of the 30 edges to 30 time points with an interval of 1s within a period of, for example, 30s, so that the failure notification is sent to one of the edges at each of the 30 time points. Each edge sends a connection request to a plurality of clouds in response to the failure notification, so that the time points at which each edge sends the connection request are also dispersed, thereby avoiding a large number of concurrent connection requests and preventing instantaneous resource tension or overload in the cloud. In the embodiments of the present disclosure, in addition to the hash processing, another dispersion manner, for example, a random manner, may be used. Details are not described herein again.

When a regional failure occurs in a specific cloud, the edges connected to the failed cloud also need to be carried by another cloud. In the case of the existing disaster recovery settings, because the capacities of the clouds may be imbalanced, and a cloud is unaware of the capacity quota or capacity occupancy of another cloud, each of all the clouds needs to prepare disaster recovery resources required for additionally connecting to all the edges connected to the clouds other than the cloud.

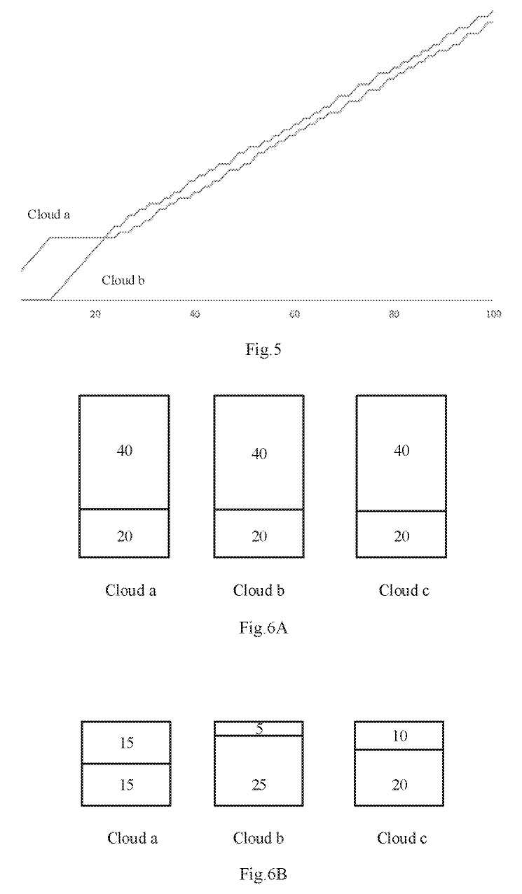

FIG. 6A is a schematic diagram of a scenario in which each of all clouds needs to prepare an amount of disaster recovery resources for connecting to all edges in a disaster recovery scenario.

As shown in FIG. 6A, it is assumed that there are three clouds in total, and the number of edges currently connected to each cloud is 20. Therefore, the total number of edges connected to all the clouds is 60. For each cloud, the number of all edges connected to clouds other than the cloud is 40. However, because it is unclear whether a specific cloud among the other clouds is connected to 40 edges, to provide disaster recovery for any cloud, each cloud still needs to be configured with 40 redundant resources. Together with the 20 edges that are already connected to the cloud, each cloud needs to be configured with an amount of disaster recovery resources for the total number, namely, 60, of edges connected to the plurality of clouds.

FIG. 6B is a schematic diagram of the amount of disaster recovery resources of a plurality of clouds in a disaster recovery scenario according to at least one embodiment of the present disclosure.

In some embodiments, the scheduling method may further include setting the amount of disaster recovery resources of the first cloud as bearing a portion of a total number of a plurality of edges connected to the plurality of clouds.

This is because according to at least one embodiment of the present disclosure, the load of each of the clouds may be balanced as much as possible, and the first cloud may know the number of edges respectively connected to clouds other than the first cloud. Therefore, the first cloud does not need to make a worst-case preparation for the case in which a specific cloud is connected to all the 40 edges, that is, does not need to prepare resources for 60 edges, but only needs to set the amount of disaster recovery resources as bearing a portion of 60 edges, because the other clouds respectively bear a portion of the 40 edges. In this way, the amount of disaster recovery resources of the cloud is reduced.

In some embodiments, a minimum value of the amount of disaster recovery resources of the first cloud may be set as N/(M–1) (without considering the resource consumption for data synchronization), where M is the number of the plurality of clouds, and N is the total number of the plurality of edges connected to the plurality of clouds. Certainly, this is a theoretically calculated minimum value, but in an actual production environment, more sufficient resources than the minimum value are reserved for each cloud.

As shown in FIG. 6B, the number of clouds, M, is 3; the number of edges currently connected to cloud a is 15; the number of edges currently connected to cloud b is 25; and the number of edges currently connected to cloud c is 20. The total number of edges connected to all the three clouds is 60. In a comparison case, the amount of disaster recovery resources for cloud a is set to 60, where the amount of redundant resources is 45, because for cloud a, the total number of edges connected to the other clouds is 45.

However, according to at least one embodiment of the present disclosure, the minimum value of the amount of disaster recovery resources of cloud a may be N/(M–1) = 60/(3–1) = 30. As shown in FIG. 6B, it is assumed that the minimum value of the amount of disaster recovery resources set for cloud a is 30, that is, 15 edges are already connected, and the amount of resources for 15 redundant edges is provided. It is assumed that the minimum value of the amount of disaster recovery resources set for cloud b is 30, 25 edges are already connected, and the amount of resources for 5 redundant edges is provided. It is assumed that the minimum value of the amount of disaster recovery resources set for cloud c is 30, 20 edges are already connected, and the amount of resources for 10 redundant edges is provided. If cloud b fails, the 25 edges connected to cloud b may be distributed to cloud a and cloud c, where the amount of redundant resources of cloud a may bear 15 edges, and the amount of redundant resources of cloud c may bear 10 edges. In this way, the minimum amount of disaster recovery resources may be used to provide disaster recovery for the cloud.

Compared with FIG. 6A, the amount of disaster recovery resources of each cloud is reduced from 60 to 30, which reduces the waste of the amount of disaster recovery resources, and enables normal disaster recovery to be performed to bear the traffic of the edges of the failed cloud, thereby achieving a balance between the quality of disaster recovery and the cost.

Certainly, the examples in FIGS. 6A and 6B are merely examples, and another numerical example may be used. In addition, the amount of disaster recovery resources may be set to be greater than the minimum value, to more fully provide disaster recovery.

In this way, when a regional failure occurs in a specific cloud, the cloud-edge traffic may be quickly scheduled to a cloud in another region, and the redundant resources used for the failure of the disaster recovery cloud may be reduced as much as possible, thereby saving the cost of cloud resources. When a specific cloud fails, the traffic is scheduled to another cloud, and the remaining healthy clouds may have the capability of bearing all the scheduled traffic. Meanwhile, during the scheduling process, the scheduling solution shown in FIG. 3 is further applied, so that precise traffic control may be performed, and the traffic of the failed cloud is scheduled to a cloud with low latency and a low load, thereby improving the service quality.

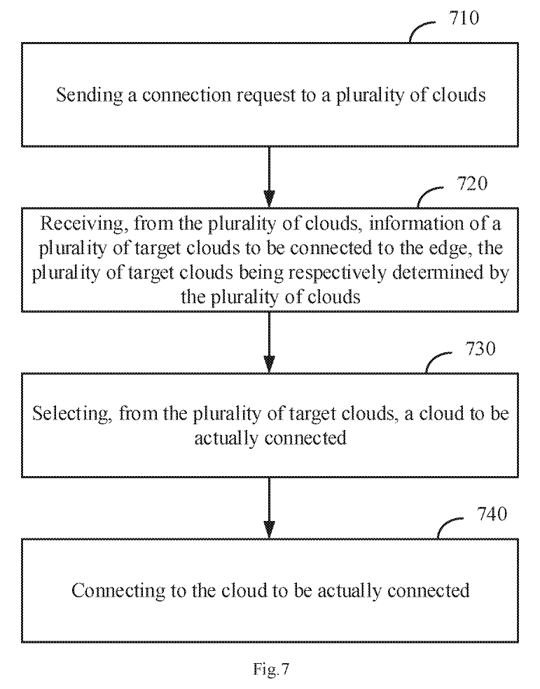

FIG. 7 is a flowchart of a scheduling method for an edge according to at least one embodiment of the present disclosure.

The scheduling method for the edge includes steps 710, 720, 730, and 740. The method may be performed by the edge shown in FIG. 2. For example, the edge includes a traffic scheduling module 211, configured to perform the scheduling method at the edge. For example, the edge may also have resources such as a processor and a memory to implement the execution of the method.

In step 710, the edge sends a connection request to a plurality of clouds. For example, the edge may simultaneously send a chooseIDC request to all the clouds, which may all carry information of transmission delay amounts from the edge to all the clouds that are detected by the edge. Then, it is determined whether responses are received from the respective clouds. It may be specified that if a response is not received from a cloud within a timeout period of 5s or an error response is received from a cloud, it is considered that the request for the cloud fails. If no response is received from all the clouds or all the responses are error responses, it is considered that the connection request fails, and step 610 may be repeated to re-initiate the connection request.

In step 720, information of a plurality of target clouds (for example, second clouds) to be connected to the edge, the plurality of target clouds being respectively determined by the plurality of clouds, is received from the plurality of clouds. Each of the plurality of target clouds is determined by a corresponding one of the plurality of clouds according to delay-capacity information, and the delay-capacity information is based on information of transmission delay amounts between the edge and the plurality of clouds, and information of capacity occupancies of the plurality of clouds, the information of transmission delay amounts and the information of capacity occupancies being obtained at the corresponding one of the plurality of clouds.

In step 730, a cloud (for example, a third cloud) to be actually connected, for example, cloud a, is selected from the plurality of target clouds.

In step 740, the cloud to be actually connected, for example, cloud a, is connected to.

In this way, during cloud-edge connection, an appropriate cloud that is scheduled by comprehensively considering both the cloud-edge delays between the respective clouds and the edge and the resource capacity occupancy of the respective clouds may be obtained from the plurality of clouds, so that the edge is connected to the appropriate cloud. Further, the service quality of a service, such as RTC, that is sensitive to latency may be ensured.

In some embodiments, the scheduling method may further include: detecting transmission delay amounts between the edge and the plurality of clouds; and sending information of the detected transmission delay amounts between the edge and the plurality of clouds to the plurality of clouds. The detection and the sending may be performed periodically, or may be performed when the connection request needs to be sent to the plurality of clouds. The time at which the detection and the sending occur is not limited herein.

In some embodiments, step 730 may include: selecting, based on an arbitration rule, the cloud to be actually connected from the plurality of target clouds. A plurality of arbitration rules may be used, and the arbitration rules are not limited to the several arbitration rules described in the present disclosure.

In some embodiments, selecting, based on the arbitration rule, the cloud to be actually connected from the plurality of target clouds may include: in response to the plurality of target clouds being a same cloud, selecting the same cloud; selecting, in response to the plurality of target clouds including at least partially different clouds and there being a cloud with a largest number of occurrences, the cloud with the largest number of occurrences in the plurality of target clouds; and selecting, in response to the plurality of target clouds including at least partially different clouds and there being no cloud with a largest number of occurrences, a target cloud determined by a predetermined cloud of the plurality of clouds. Herein, the arbitration rule is not limited to the foregoing manners, and another implementation, for example, random selection, may be used.

Herein, theoretically, all the clouds should obtain and record same information, for example, same information of the transmission delay amounts between each cloud and the edge and same information of the capacity occupancy of each cloud. Therefore, all the clouds should determine a same target cloud to be connected to the edge based on the same information and a same decision-making method. However, in actual application, a plurality of clouds may experience a brain split, that is, the information obtained and recorded at different clouds may be different due to unstable connection or untimely information transmission, and therefore different target clouds may be determined by the different clouds. In this case, the edge receives information of different target clouds. In this case, a manner in which the minority is subordinate to the majority may be followed, and a cloud with the largest number of occurrences in the plurality of target clouds is selected to be connected to.

However, there may be no cloud with the largest number of occurrences. For example, there are six clouds (cloud a, cloud b, cloud c, cloud d, cloud e, and cloud f) in total. Clouds a and b both determine cloud a, clouds c and d both determine cloud b, and clouds c and f both determine cloud c as the target cloud for the edge to select. In this case, there is no target cloud with the largest number, and it may be specified to select a target cloud determined by a predetermined cloud of the plurality of clouds. In some embodiments, the predetermined cloud may be a cloud (for example, cloud f) with a smallest identification ID in an alphabetical order. Certainly, the predetermined cloud is not limited thereto, and the predetermined cloud may alternatively be a cloud with a largest identification ID in the alphabetical order, or a second-ranked cloud, etc. The purpose of such setting is that if the plurality of target clouds include at least partially different clouds and there is no cloud with the largest number of occurrences, a target cloud (for example, cloud c) determined by a basically same cloud (for example, cloud f) is selected according to a basically same rule, so that in the case where the decision module of the cloud experiences a brain split and the minority cannot be subordinate to the majority, the connection is always made based on a target cloud (based on various information recorded by the cloud) determined by one of the clouds, instead of making the connection based on target clouds (based on different information recorded by different clouds) determined by different clouds that experience the brain split every time, which causes the selected target cloud to be selected based on inconsistent information, resulting in confusion or repeated jumping of the connection of the edge between different target clouds.

For example, after the edge selects a target cloud to actually connect to, in some embodiments, the scheduling method may further include: sending information of the actually connected cloud to the plurality of clouds, so that each cloud updates the information, recorded by the cloud, of the capacity occupancy of each cloud. This ensures that the latest information is used for subsequent decision-making of the cloud.

In this way, during cloud-edge connection, the cloud may comprehensively consider the cloud-edge delays between the respective clouds and the edge and the resource capacity occupancy of the respective clouds, and dynamically schedule the edge to an appropriate cloud, so that the edge is connected to the cloud and the cloud is responsible for the services of the edge. Further, the service quality of a service, such as RTC, that is sensitive to latency may be ensured, the cloud resources are reasonably allocated, and the cloud load is prevented from being exceeded.

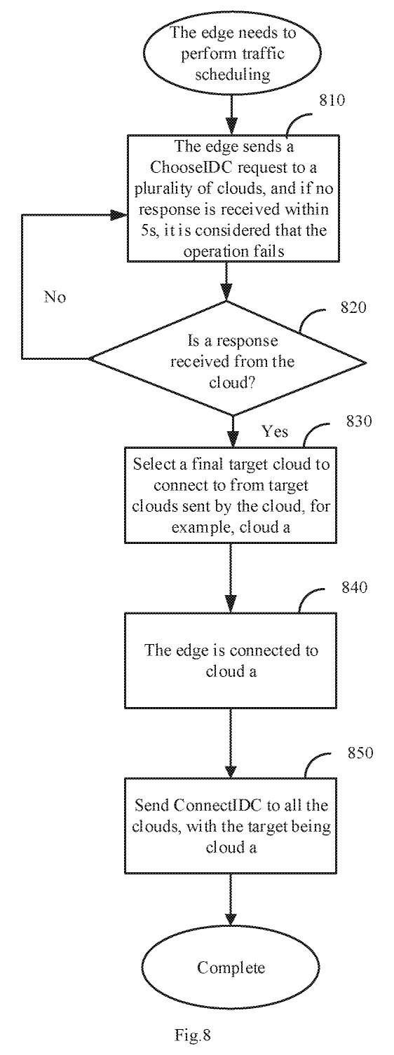

FIG. 8 is a schematic diagram of example operations of an edge according to at least one embodiment of the present disclosure.

As shown in FIG. 8, for example, a cloud that the edge is originally connected to fails, and the edge needs to perform traffic scheduling to schedule its traffic to another cloud.

In step 810, the edge sends a ChooseIDC request (that is, a connection request) to a plurality of clouds. The timeout period is set to 5s.

In step 820, it is confirmed whether a response is received from the cloud (the response is, for example, a determined target cloud returned by the cloud). If the response is not received from the cloud within 5s, it is considered that the operation fails, and the process returns to step 810 to re-send the ChooseIDC request to the plurality of clouds.

If it is confirmed that the response is received from the cloud, in step 830, the edge selects a final target cloud to connect to from the target clouds sent by the clouds, for example, cloud a.

In step 840, the edge is actually connected to the selected cloud a.

In step 850, the edge sends ConnectIDC to all the clouds, with the target being cloud a, that is, notifies all the clouds that it is actually connected to cloud a.

In this way, for example, in the case where the cloud that the edge is originally connected to fails, the edge may quickly schedule its traffic from the originally connected cloud to cloud a, thereby ensuring the quality of the service carried by the edge.

FIG. 9 is a flowchart of operations of an edge selecting, according to an arbitration rule, a cloud to be actually connected to according to at least one embodiment of the present disclosure.

As shown in FIG. 9, the edge needs to select, from target clouds returned by a plurality of clouds, a cloud to be actually connected to. In step 910, the edge determines whether the target clouds returned by the plurality of clouds are the same. If they are the same, for example, if the target clouds returned by six clouds a, b, c, d, e, and f are all cloud a, in step 920, the same target cloud, that is, cloud a, is selected to be connected to. If they are different, in step 930, it is determined whether there is a target cloud with the largest number of occurrences. If there is a target cloud with the largest number of occurrences, for example, if six clouds return four cloud a and two cloud b, in step 940, the target cloud with the largest number of occurrences, which is cloud a in this example, is selected. If there is no target cloud with the largest number of occurrences, for example, if six clouds return two cloud a, two cloud b, and two cloud c, in this step, a target cloud (for example, cloud c) returned by a cloud (for example, cloud f) with a smallest identification in an alphabetical order may be selected as the cloud to be actually connected to.

In this way, the cloud to be actually connected to may be reasonably and quickly selected and connected to. Certainly, the arbitration rule is merely an example, and the cloud to be actually connected to may be selected from the target clouds returned by the plurality of clouds based on another arbitration rule. Details are not described herein again.

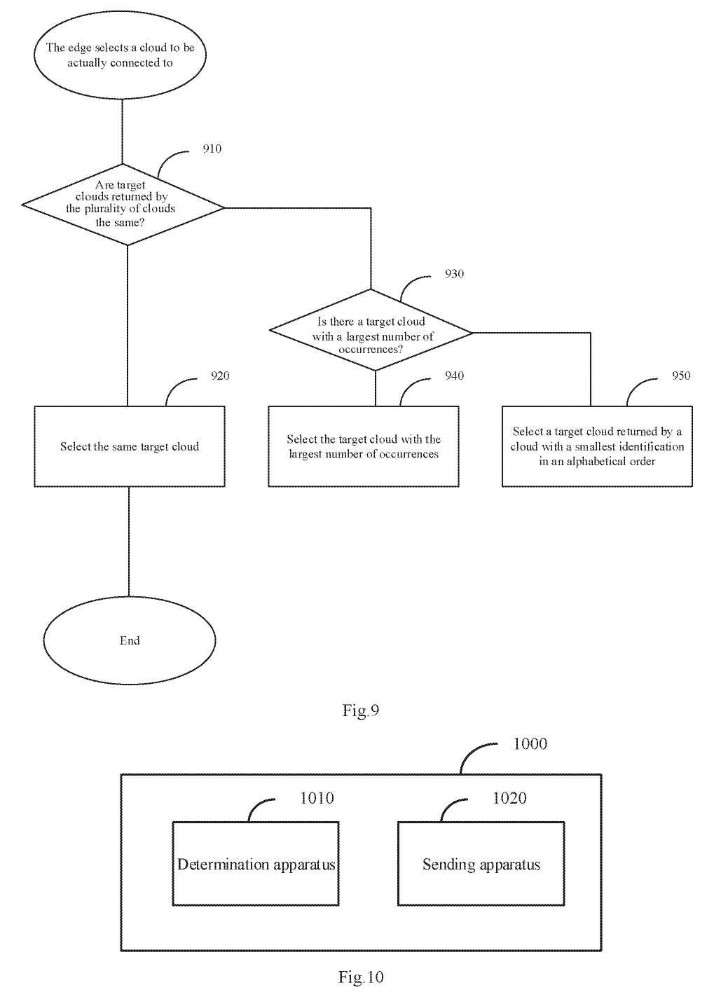

FIG. 10 is a block diagram of a cloud 1000 according to at least one embodiment of the present disclosure.

As shown in FIG. 10, the cloud 1000 includes a determination apparatus 1010 and a sending apparatus 1020.

The determination apparatus 1010 is configured to: in response to a connection request from an edge, determine, based on delay-capacity information, a target cloud to be connected to the edge from a plurality of clouds including the cloud, where the delay-capacity information includes information of transmission delay amounts between the edge and the plurality of clouds and information of capacity occupancies of the plurality of clouds that are obtained at the cloud.

The sending apparatus 1020 is configured to send information of the target cloud to the edge.

In some embodiments, the second indicator includes a first capacity indicator, where the first capacity indicator is a first constant when the capacity occupancy is less than a protection threshold, and is greater than or equal to a first value when the capacity occupancy is greater than or equal to the protection threshold, where the first value is positively correlated with the capacity occupancy, the first value is of the same order of magnitude as a maximum value of the transmission delay amount, and the protection threshold is greater than the capacity threshold.

In some embodiments, the first value has a range from half of the maximum value of the transmission delay amount to the maximum value of the transmission delay amount.

In some embodiments, the second indicator further includes a second capacity indicator, where the second capacity indicator is a second constant when the capacity occupancy is less than the capacity threshold, and is greater than or equal to a second value when the capacity occupancy is greater than or equal to the capacity threshold, where the second value is positively correlated with the capacity occupancy, and a difference between the second value and an inherent delay difference among the transmission delay amounts of the plurality of clouds is within two orders of magnitude.

In some embodiments, the delay-capacity information further includes respective capacity upper limits of the plurality of clouds, and the determination apparatus 1010 is further configured to: obtain a ratio between the respective capacity upper limits of the plurality of clouds, and determine the target cloud based on a probability corresponding to the ratio, so that a ratio of a probability of determining one of the plurality of clouds as the target cloud to a probability of determining another of the plurality of clouds as the target cloud is equal to a ratio of a capacity upper limit of the one cloud to a capacity upper limit of the another cloud.

In some embodiments, the cloud 1000 further includes an updating apparatus configured to: pre-update, in response to determining the target cloud, the information of the capacity occupancy of the target cloud obtained at the first cloud to information of a capacity occupancy of the target cloud considered as being connected to the edge; receive, from the edge, information of a cloud actually connected to the edge; and maintain the information of the pre-updated capacity occupancy of the target cloud in response to the information of the cloud actually connected to the edge being the same as the information of the target cloud; or revert the information of the pre-updated capacity occupancy of the target cloud to the information of the capacity occupancy before pre-updating and update the information of the capacity occupancy of the actually connected cloud obtained at the first cloud in response to the information of the cloud actually connected to the edge being different from the information of the target cloud.

In some embodiments, the cloud 1000 further includes: an apparatus for refusing to determine the first cloud as the target cloud in response to the capacity occupancy of the first cloud being greater than or equal to a first water level threshold; and an apparatus for disconnecting the first cloud from one or more edges in response to the capacity occupancy of the first cloud being greater than or equal to a second water level threshold, where the second water level threshold is greater than the first water level threshold.

In some embodiments, the cloud 1000 further includes a notifying apparatus configured to: in response to a failure of the first cloud, disperse time points of sending a failure notification to a plurality of edges including the edge to a plurality of different time points; and send the failure notification to the plurality of edges at the plurality of different time points, respectively.

In some embodiments, the cloud 1000 further includes a setting apparatus configured to set an amount of disaster recovery resources of the first cloud as bearing a portion of a total number of a plurality of edges connected to the plurality of clouds.

In some embodiments, a minimum value of the amount of disaster recovery resources of the first cloud is set as N/(M–1), where M is the number of the plurality of clouds, and N is the total number of the plurality of edges connected to the plurality of clouds.

FIG. 11 is a block diagram of an edge 1100 according to at least one embodiment of the present disclosure.

As shown in FIG. 11, the edge 1100 includes a sending apparatus 1110, a receiving apparatus 1120, a selecting apparatus 1130, and a connecting apparatus 1140.

The sending apparatus 1110 is configured to send a connection request to a plurality of clouds.

The receiving apparatus 1120 is configured to receive, from the plurality of clouds, information of a plurality of target clouds to be connected to the edge that are determined by the plurality of clouds, each of the plurality of target clouds being determined by a first cloud of the plurality of clouds according to delay-capacity information, and the delay-capacity information being based on information of transmission delay amounts between the edge and the plurality of clouds and information of capacity occupancies of the plurality of clouds, which are obtained at the first cloud of the plurality of clouds.

The selecting apparatus 1130 is configured to select, from the plurality of target clouds, a cloud to be actually connected.

The connecting apparatus 1140 is configured to connect to the cloud to be actually connected.

In some embodiments, the edge further includes a detecting apparatus configured to detect transmission delay amounts between the edge and the plurality of clouds, and send, to the plurality of clouds, information of the detected transmission delay amounts between the edge and the plurality of clouds.

In some embodiments, the selecting apparatus 1130 is configured to select, based on an arbitration rule, the cloud to be actually connected from the plurality of target clouds.

In some embodiments, the selecting apparatus 1130 is configured to: in response to the plurality of target clouds being a same cloud, select the same cloud; select, in response to the plurality of target clouds including at least partially different clouds and there being a cloud with a largest number of occurrences, the cloud with the largest number of occurrences in the plurality of target clouds; and select, in response to the plurality of target clouds including at least partially different clouds and there being no cloud with a largest number of occurrences, a target cloud determined by a predetermined cloud of the plurality of clouds.

In some embodiments, the sending apparatus 1110 is further configured to send information of the actually connected cloud to the plurality of clouds.

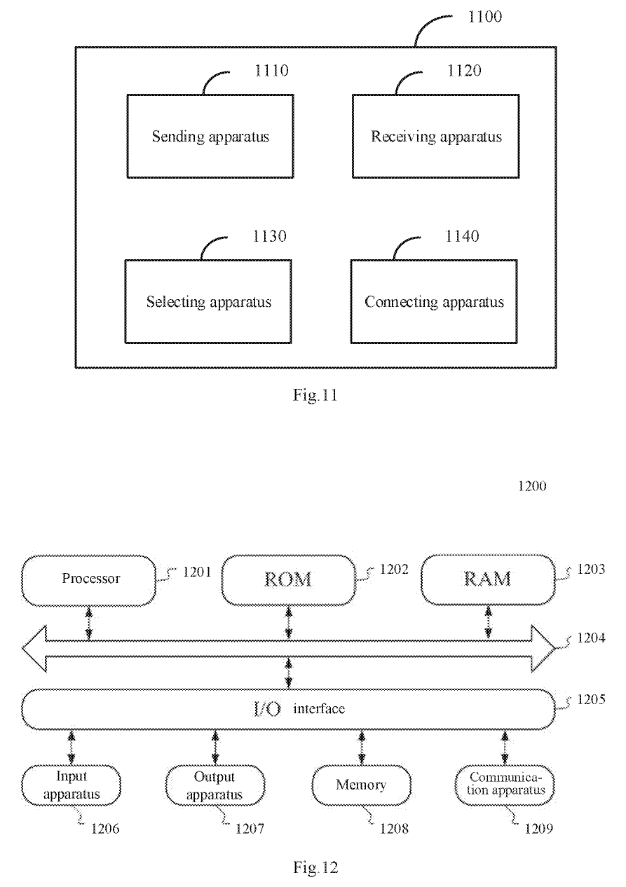

FIG. 12 is a block diagram of an electronic apparatus 1200 (for example, used to implement the cloud 1000 in FIG. 10 or the edge 1100 in FIG. 11) suitable for implementing at least one embodiment of the present disclosure.

The electronic apparatus in the embodiments of the present disclosure may be applied to a mobile terminal such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and a fixed terminal such as a digital TV, a desktop computer, and a server, and may be used, for example, to implement a computing node, to perform the task processing method in any one of the foregoing embodiments. The electronic apparatus shown in FIG. 6 is merely an example, and shall not impose any limitation on the function and scope of use of the embodiments of the present disclosure.

As shown in FIG. 12, the electronic apparatus 1200 may include a processing apparatus (such as a central processing unit and a graphics processing unit) 1201, which may perform various appropriate actions and processing based on a program stored in a read-only memory (ROM) 1202 or a program loaded from a storage apparatus 1206 into a random access memory (RAM) 1203. The RAM 1203 further stores various programs and data required for the operation of the electronic apparatus 1200, including but not limited to an operating system, applications, etc. The processing apparatus 1201, the ROM 1202, and the RAM 1203 are interconnected by means of a bus 1204. An input/output (I/O) interface 1205 is also connected to the bus 1204.

Usually, the following apparatuses may be connected to the I/O interface 1205: an input apparatus 1206 including, for example, a touch screen, a touchpad, a keyboard, a mouse, a camera, a microphone, an accelerometer, and a gyroscope; an output apparatus 1207 including, for example, a liquid crystal display (LCD), a speaker, and a vibrator; the storage apparatus 1206 including, for example, a magnetic tape and a hard disk; and a communication apparatus 1209. The communication apparatus 1209 may allow the electronic apparatus 1200 to perform wireless or wired communication with other devices to exchange data, and may include, for example, a network card and a modem. The communication apparatus 1209 works, for example, in conjunction with a driver running on the processing apparatus 1201.

Although FIG. 12 shows the electronic apparatus 1200 having various apparatuses, it should be understood that it is not required to implement or provide all the apparatuses shown. More or fewer apparatuses may alternatively be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for performing the method shown in the flowchart. In such an embodiment, the computer program may be downloaded and installed from a network through the communication apparatus 1209, or installed from the storage apparatus 1206, or installed from the ROM 1202. When the computer program is executed by the processing apparatus 1201, the foregoing functions defined in the method of the embodiments of the present disclosure are performed.

It should be noted that the foregoing computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or used in conjunction with an instruction execution system, apparatus, or device. In the present disclosure, the computer-readable signal medium may include a data signal propagated on a baseband or as a part of a carrier, and computer-readable program code is carried in the data signal. The data signal propagated in this way may be in a plurality of forms, and includes but is not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program code contained in the computer-readable medium may be transmitted in any suitable medium, including but not limited to a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the task processing apparatus, or may exist alone without being assembled into the task processing apparatus.

The computer-readable medium carries one or more programs/computer-executable code. When the one or more programs/computer-executable code are executed by a processing apparatus (such as a processor), the processing apparatus performs the operations in the embodiments of the present disclosure.

Alternatively, the computer-readable medium carries one or more programs/computer-executable code. When the one or more programs/computer-executable code are executed by the task processing apparatus, the task processing apparatus performs the operations in the present disclosure.

The computer program code for performing the operations of the present disclosure may be written in one or more programming languages or a combination thereof, where the programming languages include but are not limited to object-oriented programming languages such as Java, Smalltalk, and C++, and further include conventional procedural programming languages such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to a computer of a user through any kind of network, including a local area network (LAN) or a wide area network (WAN), or may be connected to an external computer (for example, connected through the Internet using Internet service providers).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or hardware. The name of the unit does not constitute a limitation on the unit itself under certain circumstances.

The functions described above herein may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

To sum up, the present disclosure provides the following embodiments and examples:
Example 1. A scheduling method for a first cloud of a plurality of clouds, including:
   in response to a connection request from an edge, determining, according to delay-capacity information, a target cloud to be connected to the edge from the plurality of clouds, the delay-capacity information including information of transmission delay amounts between the edge and the plurality of clouds, and information of capacity occupancies of the plurality of clouds, which are obtained at the first cloud; and
   sending information of the target cloud to the edge.
Example 2. The method of Example 1, where the determining, according to the delay-capacity information, the target cloud to be connected to the edge from the plurality of clouds includes:
   obtaining a comprehensive indicator for each of the plurality of clouds based on the transmission delay amounts and the capacity occupancies, the comprehensive indicator including a value calculated based on a first indicator and a second indicator, the first indicator being positively correlated with the transmission delay amounts, and the second indicator being positively correlated with the capacity occupancies when the capacity occupancies are greater than or equal to a capacity threshold; and
   determining the target cloud in response to a comparison between the comprehensive indicators of the plurality of clouds.
Example 3. The method of Example 2, where the second indicator includes a first capacity indicator,
   where the first capacity indicator is a first constant when the capacity occupancy is less than a protection threshold, and is greater than or equal to a first value when the capacity occupancy is greater than or equal to the protection threshold,
   where the first value is positively correlated with the capacity occupancy, and the first value is of the same order of magnitude as a maximum value of the transmission delay amount, the protection threshold is greater than the capacity threshold.
Example 4. The method of Example 3, where the first value has a range from half of the maximum value of the transmission delay amount to the maximum value of the transmission delay amount.
Example 5. The method of Example 2, where the second indicator further includes a second capacity indicator, where the second capacity indicator is a second constant when the capacity occupancy is less than the capacity threshold, and is greater than or equal to a second value when the capacity occupancy is greater than or equal to the capacity threshold,
   where the second value is positively correlated with the capacity occupancy, and a difference between the second value and an inherent delay difference among the transmission delay amounts of the plurality of clouds is within two orders of magnitude.
Example 6. The method of any one of Examples 1 to 5, where the delay-capacity information further includes respective capacity upper limits of the plurality of clouds, and the method further includes:
   obtaining a ratio between the respective capacity upper limits of the plurality of clouds, and
   determining the target cloud based on a probability corresponding to the ratio, so that a ratio of a probability of determining one of the plurality of clouds as the target cloud to a probability of determining another of the plurality of clouds as the target cloud is equal to a ratio of a capacity upper limit of the one cloud to a capacity upper limit of the another cloud.
Example 7. The method of any one of Examples 1 to 5, further including:
   pre-updating, in response to determining the target cloud, the information of the capacity occupancy of the target cloud obtained at the first cloud to information of a capacity occupancy of the target cloud considered as being connected to the edge;
   receiving, from the edge, information of a cloud actually connected to the edge; and
   maintaining the information of the pre-updated capacity occupancy of the target cloud in response to the information of the cloud actually connected to the edge being the same as the information of the target cloud; or reverting the information of the pre-updated capacity occupancy of the target cloud to the information of the capacity occupancy before pre-updating and updating the information of the capacity occupancy of the actually connected cloud obtained at the first cloud in response to the information of the cloud actually connected to the edge being different from the information of the target cloud.
Example 8. The method of any one of Examples 1 to 5, further including:
   refusing to determine the first cloud as the target cloud in response to the capacity occupancy of the first cloud being greater than or equal to a first water level threshold; and
   disconnecting the first cloud from one or more edges in response to the capacity occupancy of the first cloud being greater than or equal to a second water level threshold,
   where the second water level threshold is greater than the first water level threshold.
Example 9. The method of any one of Examples 1 to 5, further including:
   in response to a failure of the first cloud, dispersing time points of sending a failure notification to a plurality of edges including the edge to a plurality of different time points; and
   sending the failure notification to the plurality of edges at the plurality of different time points, respectively.
Example 10. The method of any one of Examples 1 to 5, further including:
   setting an amount of disaster recovery resources of the first cloud as bearing a portion of a total number of a plurality of edges connected to the plurality of clouds.
Example 11. The method of Example 10, where
   a minimum value of the amount of disaster recovery resources of the first cloud is set as N/(M–1), where M is the number of the plurality of clouds, and N is the total number of the plurality of edges connected to the plurality of clouds.
Example 12. A scheduling method for an edge, including:
   sending a connection request to a plurality of clouds;
   receiving, from the plurality of clouds, information of a plurality of target clouds to be connected to the edge, the plurality of target clouds being respectively determined by the plurality of clouds, each of the plurality of target clouds being determined by a corresponding one of the plurality of clouds according to delay-capacity information, and the delay-capacity information being based on information of transmission delay amounts between the edge and the plurality of clouds and information of capacity occupancies of the plurality of clouds, the information of transmission delay amounts and the information of capacity occupancies being obtained at the corresponding one of the plurality of clouds;
   selecting, from the plurality of target clouds, a cloud to be actually connected; and
   connecting to the cloud to be actually connected.
Example 13. The method of Example 12, further including:
   detecting the transmission delay amounts between the plurality of clouds and the edge; and
   sending information of the detected transmission delay amounts between the plurality of clouds and the edge to the plurality of clouds.
Example 14. The method of Example 12 or 13, where the selecting, from the plurality of target clouds, the cloud to be actually connected includes:
   selecting, based on an arbitration rule, the cloud to be actually connected from the plurality of target clouds.
Example 15. The method of Example 14, where the selecting, based on the arbitration rule, the cloud to be actually connected from the plurality of target clouds includes:
   in response to the plurality of target clouds being a same cloud, selecting the same cloud;
   selecting, in response to the plurality of target clouds including at least partially different clouds and there being a cloud with a largest number of occurrences, the cloud with the largest number of occurrences among the plurality of target clouds; and
   selecting, in response to the plurality of target clouds including at least partially different clouds and there being no cloud with a largest number of occurrences, a target cloud determined by a predetermined cloud among the plurality of clouds.
Example 16. The method of Example 12, further including:
   sending information of an actually connected cloud to the plurality of clouds.
Example 17. A cloud, including:
   a determination apparatus configured to: in response to a connection request from an edge, determine, based on delay-capacity information, a target cloud to be connected to the edge from a plurality of clouds including the cloud, where the delay-capacity information includes information of transmission delay amounts between the edge and the plurality of clouds and information of capacity occupancies of the plurality of clouds that are obtained at the cloud; and
   a sending apparatus configured to send information of the target cloud to the edge.
Example 18. The cloud of Example 17, where the determination apparatus is configured to:
   obtain a comprehensive indicator for each of the plurality of clouds based on the transmission delay amounts and the capacity occupancies, the comprehensive indicator including a value calculated based on a first indicator and a second indicator, the first indicator being positively correlated with the transmission delay amounts, and the second indicator being positively correlated with the capacity occupancies when the capacity occupancies are greater than or equal to a capacity threshold; and
   determine the target cloud in response to a comparison between the comprehensive indicators of the plurality of clouds.
Example 19. The cloud of Example 18, where the second indicator includes a first capacity indicator,
   where the first capacity indicator is a first constant when the capacity occupancy is less than a protection threshold, and is greater than or equal to a first value when the capacity occupancy is greater than or equal to the protection threshold,
   where the first value is positively correlated with the capacity occupancy, and the first value is of the same order of magnitude as a maximum value of the transmission delay amount,
   the protection threshold is greater than the capacity threshold.
Example 20. The cloud of Example 19, where the first value has a range from half of the maximum value of the transmission delay amount to the maximum value of the transmission delay amount.
Example 21. The cloud of Example 18, where the second indicator further includes a second capacity indicator, where the second capacity indicator is a second constant when the capacity occupancy is less than the capacity threshold, and is greater than or equal to a second value when the capacity occupancy is greater than or equal to the capacity threshold,
   where the second value is positively correlated with the capacity occupancy, and a difference between the second value and an inherent delay difference among the transmission delay amounts of the plurality of clouds is within two orders of magnitude.
Example 22. The cloud of any one of Examples 17 to 21, where the delay-capacity information further includes respective capacity upper limits of the plurality of clouds, and
   the determination apparatus is further configured to:
      obtain a ratio between the respective capacity upper limits of the plurality of clouds, and
      determine the target cloud based on a probability corresponding to the ratio, so that a ratio of a probability of determining one cloud of the plurality of clouds as the target cloud to a probability of determining another cloud of the plurality of clouds as the target cloud is equal to a ratio of a capacity upper limit of the one cloud to a capacity upper limit of the another cloud.
Example 23. The cloud of any one of Examples 17 to 21, further including an updating apparatus configured to:
   pre-update, in response to determining the target cloud, the information of the capacity occupancy of the target cloud obtained at the first cloud to information of a capacity occupancy of the target cloud considered as being connected to the edge;
   receive, from the edge, information of a cloud actually connected to the edge; and
   maintain the information of the pre-updated capacity occupancy of the target cloud in response to the information of the cloud actually connected to the edge being the same as the information of the target cloud; or revert the information of the pre-updated capacity occupancy of the target cloud to the information of the capacity occupancy before pre-updating and update the information of the capacity occupancy of the actually connected cloud obtained at the first cloud in response to the information of the cloud actually connected to the edge being different from the information of the target cloud.
Example 24. The cloud of any one of Examples 17 to 21, further including:
   an apparatus for refusing to determine the first cloud as the target cloud in response to the capacity occupancy of the first cloud being greater than or equal to a first water level threshold; and
   an apparatus for disconnecting the first cloud from one or more edges in response to the capacity occupancy of the first cloud being greater than or equal to a second water level threshold,
   where the second water level threshold is greater than the first water level threshold.
Example 25. The cloud of any one of Examples 17 to 21, further including a notifying apparatus configured to:
   in response to a failure of the first cloud, disperse time points of sending a failure notification to a plurality of edges including the edge to a plurality of different time points; and
   send the failure notification to the plurality of edges at the plurality of different time points, respectively.
Example 26. The cloud of any one of Examples 17 to 21, further including a setting apparatus configured to:
   set an amount of disaster recovery resources of the first cloud as bearing a portion of a total number of a plurality of edges connected to the plurality of clouds.
Example 27. The cloud of Example 26, where
   a minimum value of the amount of disaster recovery resources of the first cloud is set as N/(M–1), where M is the number of the plurality of clouds, and N is the total number of the plurality of edges connected to the plurality of clouds.
Example 28. An edge, including:
   a sending apparatus configured to send a connection request to a plurality of clouds;
   a receiving apparatus configured to receive, from the plurality of clouds, information of a plurality of target clouds to be connected to the edge that are determined by the plurality of clouds, each of the plurality of target clouds being determined by a first cloud of the plurality of clouds according to delay-capacity information, and the delay-capacity information being based on information of transmission delay amounts between the edge and the plurality of clouds and information of capacity occupancies of the plurality of clouds, which are obtained at the first cloud of the plurality of clouds;
   a selecting apparatus configured to select, from the plurality of target clouds, a cloud to be actually connected; and
   a connecting apparatus configured to connect to the cloud to be actually connected.
Example 29. The edge of Example 28, further including a detecting apparatus configured to:
   detect the transmission delay amounts between the plurality of clouds and the edge; and
   send information of the detected transmission delay amounts between the plurality of clouds and the edge to the plurality of clouds.
Example 30. The edge of Example 28 or 29, where the selecting apparatus is configured to:
   select, based on an arbitration rule, the cloud to be actually connected from the plurality of target clouds.
Example 31. The edge of Example 30, where the selecting apparatus is configured to:
   in response to the plurality of target clouds being a same cloud, select the same cloud;
   select, in response to the plurality of target clouds including at least partially different clouds and there being a cloud with a largest number of occurrences, the cloud with the largest number of occurrences among the plurality of target clouds; and
   select, in response to the plurality of target clouds including at least partially different clouds and there being no cloud with a largest number of occurrences, a target cloud determined by a predetermined cloud among the plurality of clouds.
Example 32. The edge of Example 28, where the sending apparatus is further configured to:
   send information of an actually connected cloud to the plurality of clouds.
Example 33. An electronic apparatus, including:
   at least one memory storing computer instructions; and
   at least one processor configured to execute the computer instructions in the at least one memory to perform the method according to any one of Examples 1 to 18.
Example 34. A non-transitory computer-readable storage medium having computer instructions stored thereon,
   where the computer instructions, when executed by at least one processor, cause the at least one processor to perform the method according to any one of Examples 1 to 18.

The above description is merely illustration of preferred embodiments of the present disclosure and applied technical principles. Those skilled in the art should understand that the scope of disclosure involved in the present disclosure is not limited to the technical solutions formed by specific combinations of the above technical features, and shall also cover other technical solutions formed by any combination of the above technical features or equivalent features thereof without departing from the above disclosed concept. For example, a technical solution formed by replacing the above features with technical features having similar functions disclosed in the present disclosure (but not limited thereto) also falls within the scope of the present disclosure.

In addition, although the various operations are depicted in a specific order, this should not be construed as requiring the operations to be performed in the specific order shown or in a sequential order. Under certain circumstances, multitasking and parallel processing may be advantageous. Similarly, although several specific implementation details are included in the foregoing discussion, these should not be construed as limiting the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are merely exemplary forms for implementing the claims.

1. A scheduling method for a first cloud of a plurality of clouds, comprising:
determining, according to delay-capacity information, a second cloud to be connected to an edge from the plurality of clouds in response to a connection request from the edge, wherein the delay-capacity information comprises information of transmission delay amounts between the edge and the plurality of clouds, and information of capacity occupancies of the plurality of clouds, which are obtained at the first cloud; and
sending information of the second cloud to the edge.

2. The method according to claim 1, wherein the determining, according to the delay-capacity information, a second cloud to be connected to the edge from the plurality of clouds comprises:
obtaining a comprehensive indicator for each of the plurality of clouds based on the transmission delay amounts and the capacity occupancies, wherein the comprehensive indicator comprises a value calculated based on a first indicator and a second indicator, the first indicator is positively correlated with the transmission delay amounts, and the second indicator is positively correlated with the capacity occupancies when the capacity occupancies are greater than or equal to a capacity threshold; and
determining the second cloud in response to a comparison between the comprehensive indicators of the plurality of clouds.

3. The method according to claim 2, wherein the second indicator comprises a first capacity indicator,
wherein the first capacity indicator is a first constant when the capacity occupancy is less than a protection threshold, and is greater than or equal to a first value when the capacity occupancy is greater than or equal to the protection threshold,
wherein the first value is positively correlated with the capacity occupancy, and the first value is of the same order of magnitude as a maximum value of the transmission delay amount, and
the protection threshold is greater than the capacity threshold.

4. The method according to claim 3, wherein the first value has a range from half of the maximum value of the transmission delay amount to the maximum value of the transmission delay amount.

5. The method according to claim 2, wherein the second indicator further comprises a second capacity indicator, wherein the second capacity indicator is a second constant when the capacity occupancy is less than the capacity threshold, and is greater than or equal to a second value when the capacity occupancy is greater than or equal to the capacity threshold,
wherein the second value is positively correlated with the capacity occupancy, and a difference between the second value and an inherent delay difference among the transmission delay amounts of the plurality of clouds is within two orders of magnitude.

6. The method according to claim 1, wherein the delay-capacity information further comprises respective capacity upper limits of the plurality of clouds, and
the determining, according to delay-capacity information, a second cloud to be connected to an edge from the plurality of clouds further comprises:
obtaining a ratio between the respective capacity upper limits of the plurality of clouds, and
determining the second cloud based on a probability corresponding to the ratio, such that a ratio of a probability of determining one cloud of the plurality of clouds as the second cloud to a probability of determining another cloud of the plurality of clouds as the second cloud is equal to a ratio of a capacity upper limit of the one cloud to a capacity upper limit of the another cloud.

7. The method according to claim 1, further comprising:
pre-updating, in response to determining the second cloud, the information of the capacity occupancy of the second cloud obtained at the first cloud to information of a capacity occupancy of the second cloud considered as being connected to the edge;
receiving, from the edge, information of a third cloud actually connected to the edge; and
maintaining the information of the pre-updated capacity occupancy of the second cloud in response to the information of the third cloud connected to the edge being the same as the information of the second cloud; or reverting the information of the pre-updated capacity occupancy of the second cloud to the information of the capacity occupancy before pre-updating and updating the information of the capacity occupancy of the third cloud obtained at the first cloud in response to the information of the third cloud connected to the edge being different from the information of the second cloud.

8. The method according to claim 1, further comprising:
refusing to determine the first cloud as the second cloud in response to the capacity occupancy of the first cloud being greater than or equal to a first water level threshold; and
disconnecting the first cloud from one or more edges in response to the capacity occupancy of the first cloud being greater than or equal to a second water level threshold,
wherein the second water level threshold is greater than the first water level threshold.

9. The method according to claim 1, further comprising:
in response to a failure of the first cloud, dispersing time points of sending a failure notification to a plurality of edges comprising the edge to a plurality of different time points; and
sending the failure notification to the plurality of edges at the plurality of different time points, respectively.

10. The method according to claim 1, further comprising:
setting an amount of disaster recovery resources of the first cloud as bearing a portion of a total number of a plurality of edges connected to the plurality of clouds.

11. The method according to claim 10, wherein
a minimum value of the amount of disaster recovery resources of the first cloud is set as N/(M–1), wherein M is a number of the plurality of clouds, and N is a total number of the plurality of edges connected to the plurality of clouds.

12. A scheduling method for an edge, comprising:
sending a connection request to a plurality of clouds;
receiving, from the plurality of clouds, information of a plurality of second clouds to be connected to the edge, the plurality of second clouds being respectively determined by the plurality of clouds, wherein each of the plurality of second clouds is determined by a corresponding one of the plurality of clouds according to delay-capacity information , and the delay capacity information is based on information of transmission delay amounts between the edge and the plurality of clouds and information of capacity occupancies of the plurality of clouds, the information of transmission delay amounts and the information of capacity occupancies being obtained at the corresponding one of the plurality of clouds;
selecting, from the plurality of second clouds, a third cloud; and
connecting to the third cloud.

13. The method according to claim 12, further comprising:
detecting the transmission delay amounts between the plurality of clouds and the edge; and
sending information of the detected transmission delay amounts between the plurality of clouds and the edge to the plurality of clouds.

14. The method according to claim 12, wherein the selecting, from the plurality of second clouds, a third cloud comprises:
selecting, based on an arbitration rule, the third cloud from the plurality of second clouds.

15. The method according to claim 14, wherein the selecting, based on an arbitration rule, the third cloud from the plurality of second clouds comprises:
in response to the plurality of second clouds being a same cloud, selecting the same cloud;
selecting, in response to the plurality of second clouds comprising at least partially different clouds and there being a cloud with a largest number of occurrences, the cloud with the largest number of occurrences among the plurality of second clouds; and
selecting, in response to the plurality of second clouds comprising at least partially different clouds and there being no cloud with a largest number of occurrences, a second cloud determined by a predetermined cloud among the plurality of clouds.

16. The method according to claim 12, further comprising:
sending information of the third cloud to the plurality of clouds.

17. An electronic apparatus, comprising:
at least one memory, storing computer instructions; and
at least one processor, configured to execute the computer instructions in the at least one memory to perform a scheduling method for a first cloud of a plurality of clouds, comprising:
determining, according to delay-capacity information, a second cloud to be connected to an edge from the plurality of clouds in response to a connection request from the edge, wherein the delay-capacity information comprises information of transmission delay amounts between the edge and the plurality of clouds, and information of capacity occupancies of the plurality of clouds, which are obtained at the first cloud; and
sending information of the second cloud to the edge.

18. An electronic apparatus, comprising:
at least one memory, storing computer instructions; and
at least one processor, configured to execute the computer instructions in the at least one memory to perform the method according to claim 12.

19. A non-transitory computer-readable storage medium having computer instructions stored thereon,
wherein the computer instructions, when executed by at least one processor, cause the at least one processor to perform the method according to claim 1.

20. A non-transitory computer-readable storage medium having computer instructions stored thereon,
wherein the computer instructions, when executed by at least one processor, cause the at least one processor to perform the method according to claim 12.
